(19) United States
(12) Patent Application Publication
(10) Pub. No.: US 2023/0187677 A1
(43) Pub. Date: Jun. 15, 2023

(54) SYSTEM AND METHOD OF CONTROLLING COMBUSTOR DYNAMICS WITH A FUEL CELL

(71) Applicant: General Electric Company, Schenectady, NY (US)

(72) Inventors: Honggang Wang, Clifton Park, NY (US); Fei Han, Clifton Park, NY (US)

(21) Appl. No.: 17/550,368

(22) Filed: Dec. 14, 2021

(51) Int. Cl. H01M 8/2404

(52) U.S. Cl. CPC H01M 8/2404; B64D 2041/005

(57) ABSTRACT

A propulsion system including: a fuel cell assembly comprising a fuel cell, the fuel cell defining an outlet positioned to remove output products from the fuel cell and a fuel cell assembly operating condition; a turbomachine comprising a compressor section, a combustion section, and a turbine section arranged in serial flow order, the combustion section configured to receive a flow of aviation fuel from the aircraft fuel supply and further configured to receive the output products from the fuel cell; and a controller comprising memory and one or more processors, the memory storing instructions that when executed by the one or more processors cause the propulsion system to perform operations including: delivering the output products from the fuel cell to the combustion section to mitigate combustion dynamics within the combustion section.

### FIELD

The present disclosure relates to a system and method for controlling combustor dynamics in a propulsion system for a gas turbine engine, the propulsion system including a fuel cell.

### BACKGROUND

A gas turbine engine generally includes a turbomachine and a rotor assembly. Gas turbine engines, such as turbofan engines, may be used for aircraft propulsion. In the case of a turbofan engine, the turbomachine includes a compressor section, a combustion section, and a turbine section in serial flow order, and the rotor assembly is configured as a fan assembly.

During operation, air is compressed in the compressor and mixed with fuel and ignited in the combustion section for generating combustion gases which flow downstream through the turbine section. The turbine section extracts energy therefrom for rotating the compressor section and fan assembly to power the gas turbine engine and propel an aircraft incorporating such a gas turbine engine in flight.

Various operating parameters such as fuel temperature, fuel composition, ambient operating conditions and/or operational load on the gas turbine engine may result in combustion dynamics or pressure pulses within the combustion section. Combustion dynamics is a result of interaction between heat release from combusting fuel-air mixture and pressure oscillations in the combustion chamber. These dynamic pressure waves may range in frequency from a few hertz to a few thousand hertz. Combustion dynamics in the form of fluctuations in pressure, heat-release rate, and other perturbations in flow may lead to problems such as structural vibration, excessive heat transfer to a chamber, and consequently may lead to failure of the system. Specifically, the pressure pulses can result in mechanical damage to combustor and turbine components and smothering of the flame in the combustor (“lean blow-out”).

Thus, there is a need for improved system to reduce combustion dynamics. As may be appreciated, mitigating combustion dynamics can advantageously increase the operational flexibility of the gas turbine engine.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a perspective view of an integrated fuel cell and combustor assembly in accordance with the present disclosure.

FIG. 3 is a schematic, axial view of the exemplary integrated fuel cell and combustor assembly of FIG. 2.

FIG. 4 is a schematic view of a fuel cell of a fuel cell assembly in accordance with an exemplary aspect of the present disclosure as may be incorporated into the exemplary integrated fuel cell and combustor assembly of FIG. 2.

FIG. 5 is a schematic diagram of a gas turbine engine including an integrated fuel cell and combustor assembly in accordance with an exemplary aspect of the present disclosure.

FIG. 6 is a schematic view of a vehicle and propulsion system in accordance with an exemplary aspect of the present disclosure.

FIG. 7 is a flow chart of a method of operating a propulsion system in accordance with exemplary embodiments of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” or “at least one of A, B, or C” refers only A, only B, only C, or any combination of A, B, and C.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degree Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine.

The phrase “combustion dynamics” may refer to fluctuations, oscillations, or pulses in pressure, heat-release rate, and/or a flow rate of combustion gases within the combustion section of a gas turbine engine. Specifically, “combustion dynamics” refers to the fluctuations in pressure, heat-release rate, and/or flow rates that are outside of normal or nominal operating conditions in the combustion section of the gas turbine engine. The combustion dynamic waves may range in frequency from a few hertz to a few thousand hertz.

A system and method are provided for operating a propulsion system of an aircraft to mitigate combustion dynamics within the combustion section. The propulsion system includes a fuel cell assembly having a fuel cell. the fuel cell defines an outlet that is positioned to remove output products from the fuel cell and a fuel cell assembly operating condition. The propulsion system further includes a turbomachine that has a compressor section, a combustion section, and a turbine section arranged in serial flow order. The combustion section is configured to receive a flow of aviation fuel from the aircraft fuel supply and is further configured to receive the output products from the fuel cell. The system and method are configured to deliver output products from the fuel cell to the combustion section to mitigate the combustion dynamics within the combustion section.

Delivery of the output products from the fuel cell to the combustion section may be based on open loop control, such that the output products are delivered in a predetermined quantity, a predetermined composition, and/or a predetermined location based on stored data in a lookup table, which as used herein refers generally to a chart, a schedule, or other similarly organized stored data. In such instances, the delivery of the output products to the combustion section may be according to a predetermined schedule of the propulsion system based on or more operating conditions or parameters in order to mitigate (e.g., reduce, combat, or entirely eliminate) combustion dynamics (e.g., pressure fluctuations) that could otherwise arise during operation of the propulsion system.

Additionally, or alternatively, an operating condition of the fuel cell assembly may be modified based on data received, e.g., the fuel cell assembly may be operated based on closed-loop control. The fuel cell assembly operating condition may be at least one of a fuel processing unit operating condition, an air processing unit operating condition, a fuel cell exhaust condition (including the selective distribution of output products), or a fuel cell operating condition. The fuel cell operating condition may be actively modified based on sensed parameters or feedback control. For example, the system and method may include receiving data indicative of combustion dynamics within the combustion section. In response to receiving data indicative of the combustion dynamics within the combustion section, the system and method may further include modifying the fuel cell assembly operating condition to mitigate the combustion dynamics.

A system and method of the present disclosure, such as one or more of the systems and methods described above, may advantageously generally prevent, reduce, or eliminate combustion dynamics within the combustion section, which could otherwise reduce engine efficiency or damage engine hardware. More specifically, a system and method of the present disclosure, such as one or more of the systems and methods described above, may mitigate combustion dynamics utilizing a fuel cell assembly integrated with the gas turbine engine, minimizing the need for other combustion dynamics mitigation devices, potentially reducing a cost, weight, and complexity of the gas turbine engine.

As will be discussed in more detail below, fuel cells are electro-chemical devices which can convert chemical energy from a fuel into electrical energy through an electro-chemical reaction of the fuel, such as hydrogen, with an oxidizer, such as oxygen contained in the atmospheric air. Fuel cell systems may advantageously be utilized as an energy supply system because fuel cell systems may be considered environmentally superior and highly efficient when compared to at least certain existing systems. To improve system efficiency and fuel utilization and reduce external water usage, the fuel cell system may include an anode recirculation loop. As a single fuel cell can only generate about 1V voltage, a plurality of fuel cells may be stacked together (which may be referred to as a fuel cell stack) to generate a desired voltage. Fuel cells may include Solid Oxide Fuel Cells (SOFC), Molten Carbonate Fuel Cells (MCFC), Phosphoric Acid Fuel Cells (PAFC), and, Proton Exchange Membrane Fuel Cells (PEMFC), all generally named after their respective electrolytes.

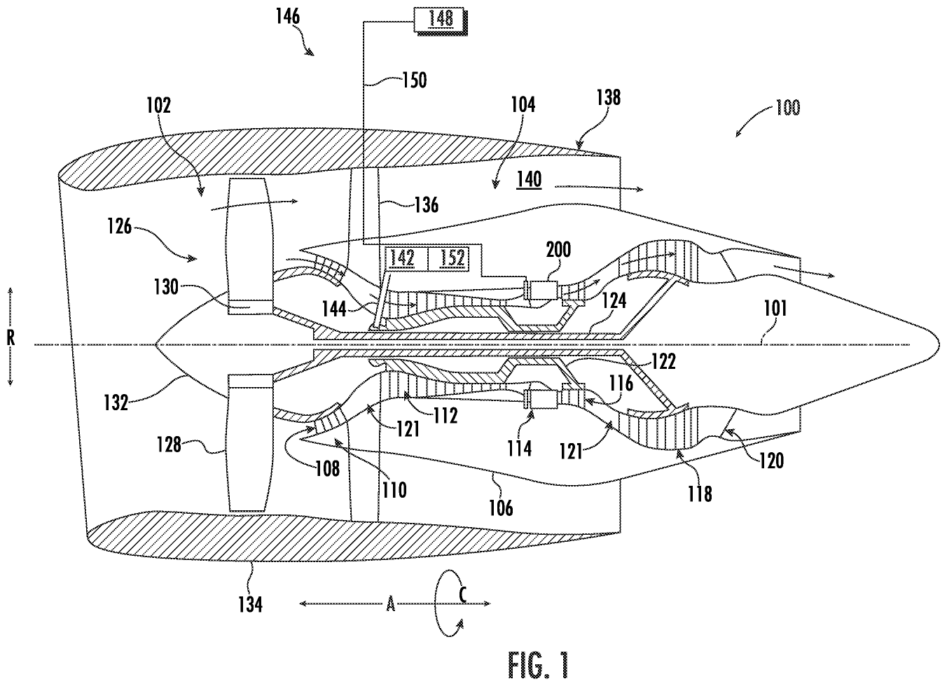

Referring now to the drawings, wherein identical numerals indicate the same elements throughout the figures, FIG. 1 provides a schematic, cross-sectional view of an engine in accordance with an exemplary embodiment of the present disclosure. The engine may be incorporated into a vehicle. For example, the engine may be an aeronautical engine incorporated into an aircraft. Alternatively, however, the engine may be any other suitable type of engine for any other suitable vehicle.

For the embodiment depicted, the engine is configured as a high bypass turbofan engine 100. As shown in FIG. 1, the turbofan engine 100 defines an axial direction A (extending parallel to a centerline axis 101 provided for reference), a radial direction R extending perpendicularly to the axial direction A, and a circumferential direction C extending about the axial direction A. In general, the turbofan engine 100 includes a fan section 102 and a turbomachine 104 disposed downstream from the fan section 102.

The exemplary turbomachine 104 depicted generally includes a substantially tubular outer casing 106 that defines an annular inlet 108. The outer casing 106 encases, in serial flow relationship, a compressor section including a booster or low pressure (LP) compressor 110 and a high pressure (HP) compressor 112; a combustion section 114; a turbine section including a high pressure (HP) turbine 116 and a low pressure (LP) turbine 118; and a jet exhaust nozzle section 120. The compressor section, combustion section 114, and turbine section together define at least in part a core air flowpath 121 extending from the annular inlet 108 to the jet nozzle exhaust section 120. The turbofan engine further includes one or more drive shafts. More specifically, the turbofan engine includes a high pressure (HP) shaft or spool 122 drivingly connecting the HP turbine 116 to the HP compressor 112, and a low pressure (LP) shaft or spool 124 drivingly connecting the LP turbine 118 to the LP compressor 110.

For the embodiment depicted, the fan section 102 includes a fan 126 having a plurality of fan blades 128 coupled to a disk 130 in a spaced apart manner. The plurality of fan blades 128 and disk 130 are together rotatable about the centerline axis 101 by the LP shaft 124. The disk 130 is covered by a rotatable front hub 132 aerodynamically contoured to promote an airflow through the plurality of fan blades 128. Further, an annular fan casing or outer nacelle 134 is provided, circumferentially surrounding the fan 126 and/or at least a portion of the turbomachine 104. The nacelle 134 is supported relative to the turbomachine 104 by a plurality of circumferentially-spaced outlet guide vanes 136. A downstream section 138 of the nacelle 134 extends over an outer portion of the turbomachine 104 so as to define a bypass airflow passage 140 therebetween.

In such a manner, it will be appreciated that turbofan engine 100 generally includes a first stream (e.g., core air flowpath 121) and a second stream (e.g., bypass airflow passage 140) extending parallel to the first stream. In certain exemplary embodiments, the turbofan engine 100 may further define a third stream extending, e.g., from the LP compressor 110 to the bypass airflow passage 140 or to ambient. With such a configuration, the LP compressor 110 may generally include a first compressor stage configured as a ducted mid-fan and downstream compressor stages. An inlet to the third stream may be positioned between the first compressor stage and the downstream compressor stages.

Referring still to FIG. 1, the turbofan engine 100 additionally includes an accessory gearbox 142 and a fuel delivery system 146. For the embodiment shown, the accessory gearbox 142 is located within the cowling/outer casing 106 of the turbomachine 104. Additionally, it will be appreciated that for the embodiment depicted schematically in FIG. 1, the accessory gearbox 142 is mechanically coupled to, and rotatable with, one or more shafts or spools of the turbomachine 104. For example, in the exemplary embodiment depicted, the accessory gearbox 142 is mechanically coupled to, and rotatable with, the HP shaft 122 through a suitable geartrain 144. The accessory gearbox 142 may provide power to one or more suitable accessory systems of the turbofan engine 100 during at least certain operations, and may further provide power back to the turbofan engine 100 during other operations. For example, the accessory gearbox 142 is, for the embodiment depicted, coupled to a starter motor/generator 152. The starter motor/generator may be configured to extract power from the accessory gearbox 142 and turbofan engine 100 during certain operation to generate electrical power, and may provide power back to the accessory gearbox 142 and turbofan engine 100 (e.g., to the HP shaft 122) during other operations to add mechanical work back to the turbofan engine 100 (e.g., for starting the turbofan engine 100).

Moreover, the fuel delivery system 146 generally includes a fuel source 148, such as a fuel tank, and one or more fuel delivery lines 150. The one or more fuel delivery lines 150 provide a fuel flow through the fuel delivery system 146 to the combustion section 114 of the turbomachine 104 of the turbofan engine 100. As will be discussed in more detail below, the combustion section 114 includes an integrated fuel cell and combustor assembly 200. The one or more fuel delivery lines 150, for the embodiment depicted, provide a flow of fuel to the integrated fuel cell and combustor assembly 200.

It will be appreciated, however, that the exemplary turbofan engine 100 depicted in FIG. 1 is provided by way of example only. In other exemplary embodiments, any other suitable gas turbine engine may be utilized with aspects of the present disclosure. For example, in other embodiments, the turbofan engine may be any other suitable gas turbine engine, such as a turboshaft engine, turboprop engine, turbojet engine, etc. In such a manner, it will further be appreciated that in other embodiments the gas turbine engine may have any other suitable configuration, such as any other suitable number or arrangement of shafts, compressors, turbines, fans, etc. Further, although the exemplary gas turbine engine depicted in FIG. 1 is shown schematically as a direct drive, fixed-pitch turbofan engine, in other embodiments, a gas turbine engine of the present disclosure may be a geared gas turbine engine (i.e., including a gearbox between the fan 126 and a shaft driving the fan, such as the LP shaft 124), may be a variable pitch gas turbine engine (i.e., including a fan 126 having a plurality of fan blades 128 rotatable about their respective pitch axes), etc. Moreover, although the exemplary turbofan engine 100 includes a ducted fan 126, in other exemplary aspects, the turbofan engine 100 may include an unducted fan 126 (or open rotor fan), without the nacelle 134. Further, although not depicted herein, in other embodiments the gas turbine engine may be any other suitable type of gas turbine engine, such as a nautical gas turbine engine.

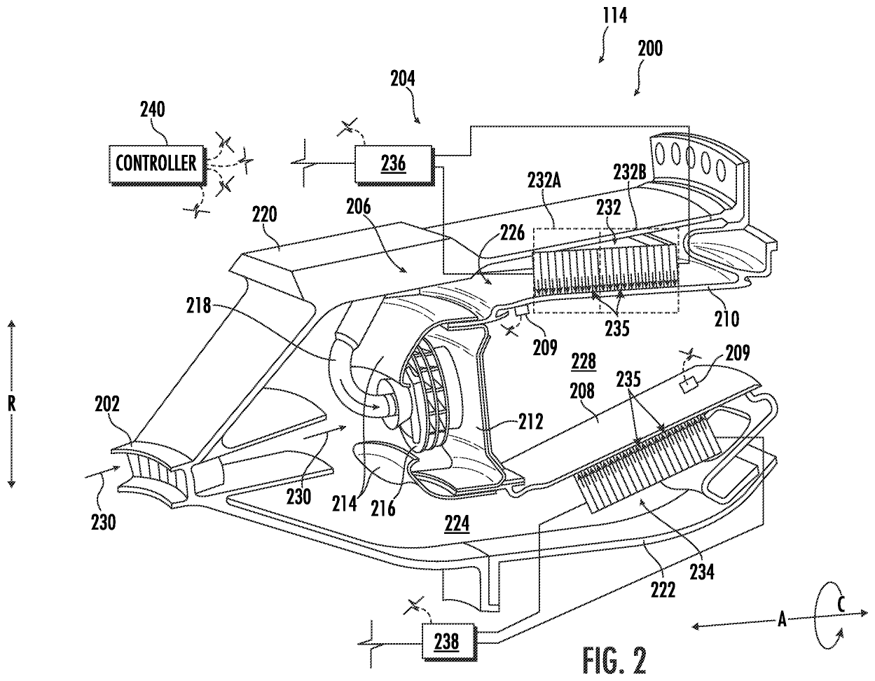

Referring now to FIG. 2, FIG. 2 illustrates schematically a portion of the combustion section 114 including a portion of the integrated fuel cell and combustor assembly 200 used in the gas turbine engine 100 of FIG. 1 (described as a turbofan engine 100 above with respect to FIG. 1), according to an embodiment of the present disclosure.

As will be appreciated, the combustion section 114 includes a compressor diffuser nozzle 202 and extends between an upstream end and a downstream end generally along the axial direction A. The combustion section 114 is fluidly coupled to the compressor section at the upstream end via the compressor diffuser nozzle 202 and to the turbine section at the downstream end.

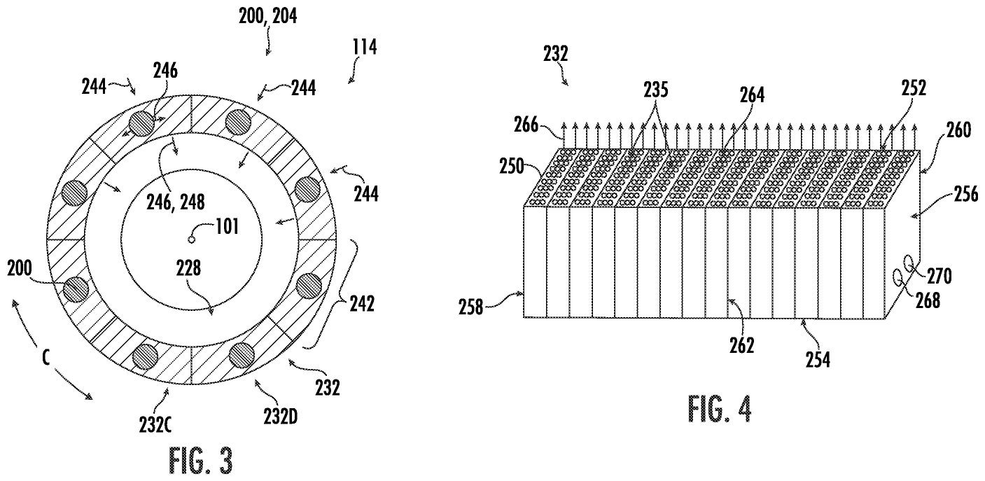

The integrated fuel cell and combustor assembly 200 generally includes a fuel cell assembly 204 (only partially depicted in FIG. 2; see also FIGS. 3 through 5) and a combustor 206. The combustor 206 includes an inner liner 208, an outer liner 210, a dome assembly 212, a cowl assembly 214, a swirler assembly 216, and a fuel flowline 218. The combustion section 114 generally includes an outer casing 220 outward of the combustor 206 along the radial direction R to enclose the combustor 206 and an inner casing 222 inward of the combustor 206 along the radial direction R. The inner casing 222 and inner liner 208 define an inner passageway 224 therebetween, and the outer casing 220 and outer liner 210 define an outer passageway 226 therebetween. The inner casing 222, the outer casing 220, and the dome assembly 212 together define at least in part a combustion chamber 228 of the combustor 206.

The dome assembly 212 is disposed proximate the upstream end of the combustion section 114 (i.e., closer to the upstream end than the downstream end) and includes an opening (not labeled) for receiving and holding the swirler assembly 216. The swirler assembly 216 also includes an opening for receiving and holding the fuel flowline 218. The fuel flowline 218 is further coupled to the fuel source 148 (see FIG. 1) disposed outside the outer casing 220 along the radial direction R and configured to receive the fuel from the fuel source 148. In such a manner, the fuel flowline 218 may be fluidly coupled to the one or more fuel delivery lines 150 described above with reference to FIG. 1.

The swirler assembly 216 can include a plurality of swirlers (not shown) configured to swirl the compressed fluid before injecting it into the combustion chamber 228 to generate combustion gas. The cowl assembly 214, in the embodiment depicted, is configured to hold the inner liner 208, the outer liner 210, the swirler assembly 216, and the dome assembly 212 together.

During operation, the compressor diffuser nozzle 202 is configured to direct a compressed fluid 230 from the compressor section to the combustor 206, where the compressed fluid 230 is configured to be mixed with fuel within the swirler assembly 216 and combusted within the combustion chamber 228 to generate combustion gasses. The combustion gasses are provided to the turbine section to drive one or more turbines of the turbine section (e.g., the high pressure turbine 116 and low pressure turbine 118).

As mentioned above and depicted schematically in FIG. 2, the integrated fuel cell and combustor assembly 200 further includes the fuel cell assembly 204. The exemplary fuel cell assembly 204 depicted includes a first fuel cell stack 232 and a second fuel cell stack 234. More specifically, the first fuel cell stack 232 is configured with the outer liner 210 and the second fuel cell stack 234 is configured with the inner liner 208. More specifically, still, the first fuel cell stack 232 is integrated with the outer liner 210 and the second fuel cell stack 234 is integrated with the inner liner 208. Operation of the fuel cell assembly 204, and more specifically of a fuel cell stack (e.g., first fuel cell stack 232 or second fuel cell stack 234) of the fuel cell assembly 204 will be described in more detail below.

For the embodiment depicted, the fuel cell assembly 204 is configured as a solid oxide fuel cell (“SOFC”) assembly, with the first fuel cell stack 232 configured as a first SOFC fuel cell stack and the second fuel cell stack 234 configured as a second SOFC fuel cell stack (each having a plurality of SOFC's). As will be appreciated, a SOFC is generally an electrochemical conversion device that produces electricity directly from oxidizing a fuel. In generally, fuel cell assemblies, and in particular fuel cells, are characterized by an electrolyte material utilized. The SOFC's of the present disclosure may generally include a solid oxide or ceramic electrolyte. This class of fuel cells generally exhibit high combined heat and power efficiency, long-term stability, fuel flexibility, and low emissions.

Moreover, the exemplary fuel cell assembly 204 further includes a first power converter 236 and a second power converter 238. The first fuel cell stack 232 is in electrical communication with the first power converter 236 by a first plurality of power supply cables (not labeled), and the second fuel cell stack 234 is in electrical communication with the second power converter 238 by a second plurality of power supply cables (not labeled).

The first power converter 236 controls the electrical current drawn from the corresponding first fuel cell stack 232 and may convert the electrical power from a direct current (“DC”) power to either DC power at another voltage level or alternating current (“AC”) power. Similarly, the second power converter 238 controls the electrical current drawn from the second fuel cell stack 234 and may convert the electrical power from a DC power to either DC power at another voltage level or AC power. The first power converter 236, the second power converter 238, or both may be electrically coupled to an electric bus (such as the electric bus 326 described below).

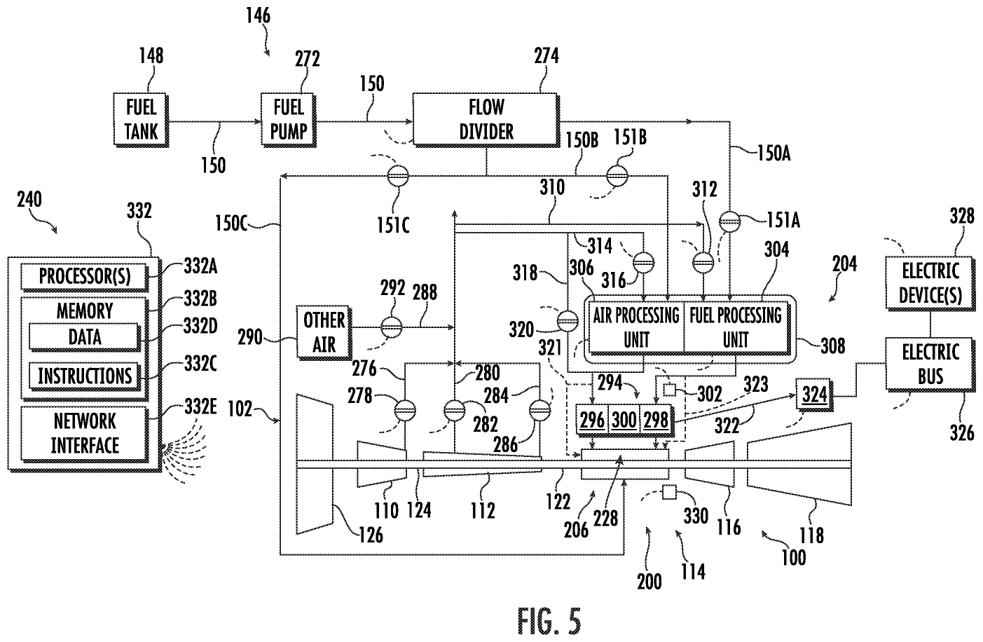

The integrated fuel cell and combustor assembly 200 further includes a fuel cell controller 240 that is in operable communication with both of the first power converter 236 and second power converter 238 to, e.g., send and receive communications and signals therebetween. For example, the fuel cell controller 240 may send current or power setpoint signals to the first power converter 236 and second power converter 238, and may receive, e.g., a voltage or current feedback signal from the first power converter 236 and second power converter 238. The fuel cell controller 240 may be configured in the same manner as the controller 240 described below with reference to FIG. 5.

In many embodiments, the integrated fuel cell and combustor assembly 200 may include one or more sensors 209 in operable communication with the controller 240. In exemplary embodiments, the one or more sensors 209 may be configured to sense data indicative of fluctuations in pressure, heat-release rate, and/or in a flow rate of combustion gases (which may also be referred to as combustion dynamics). Particularly, the one or more sensors 209 may each be a dynamics pressure sensor configured to sense data indicative of fluctuations, pulses, or oscillations in pressure within the combustion chamber 228. As shown, the one or more sensors 209 may be disposed within the combustion chamber 228. For example, the one or more sensors 209 may be disposed on, and coupled to, the inner liner 208 and/or the outer liner 210. Alternatively, the one or more sensors 209 may be disposed on, and coupled to, any other component within the combustion chamber 228 or outside of the combustion chamber 228. Additionally, as shown, the one or more sensors 209 may be disposed forward of and/or aft of the first fuel cell stack 232 and second fuel cell stack 234.

It will be appreciated that in at least certain exemplary embodiments the first fuel cell stack 232, the second fuel cell stack 234, or both may extend substantially 360 degrees in a circumferential direction C of the gas turbine engine (i.e., a direction extending about the centerline axis 101 of the gas turbine engine 100). For example, referring now to FIG. 3, a simplified cross-sectional view of the integrated fuel cell and combustor assembly 200 is depicted according to an exemplary embodiment of the present disclosure. Although only the first fuel cell stack 232 is depicted in FIG. 3 for simplicity, the second fuel cell stack 234 may be configured in a similar manner.

As shown, the first fuel cell stack 232 extends around the combustion chamber 228 in the circumferential direction C, completely encircling the combustion chamber 228 around the centerline axis 101 in the embodiment shown. More specifically, the first fuel cell stack 232 includes a plurality of fuel cells 242 arranged along the circumferential direction C. The fuel cells 242 that are visible in FIG. 3 can be a single ring of fuel cells 242, with fuel cells 242 stacked together along the axial direction A (see FIG. 2) to form the first fuel cell stack 232. In another instance, multiple additional rings of fuel cells 242 can be placed on top of each other to form the first fuel cell stack 232 that is elongated along the centerline axis 101.

As will be explained in more detail, below, with reference to FIG. 5, the fuel cells 242 in the first fuel cell stack 232 are positioned to receive discharged air 244 from, e.g., the compressor section and fuel 246 from the fuel delivery system 146. The fuel cells 242 generate electrical current using this air 244 and at least some of this fuel 246, and radially direct partially oxidized fuel 246 and unused portion of air 248 into the combustion chamber 228 toward the centerline axis 101. The integrated fuel cell and combustor assembly 200 combusts the partially oxidized fuel 246 and air 248 in the combustion chamber 228 into combustion gasses that are directed downstream into the turbine section to drive or assist with driving the one or more turbines therein.

Moreover, referring now to FIG. 4, a schematic illustration is provided as a perspective view of the first fuel cell stack 232 of the integrated fuel cell and combustor assembly 200 of FIG. 2. The second fuel cell stack 234 may be formed in a similar manner.

The first fuel cell stack 232 depicted includes a housing 250 having a combustion outlet side 252 and a side 254 that is opposite to the combustion outlet side 252, a fuel and air inlet side 256 and a side 258 that is opposite to the fuel and air inlet side 256, and sides 260, 262. The side 260, the side 258, and the side 254 are not visible in the perspective view of FIG. 4.

As will be appreciated, the first fuel cell stack 232 may include a plurality of fuel cells that are “stacked,” e.g., side-by-side from one end of the first fuel cell stack 232 (e.g., fuel and air inlet side 256) to another end of the first fuel cell stack 232 (e.g., side 258). As such, it will further be appreciated that the combustion outlet side 252 includes a plurality of combustion outlets 264, each from a fuel cell of the first fuel cell stack 232. During operation, combustion gas 266 (also referred to herein as “output products”) is directed from the combustion outlets 264 out of the housing 250. As described herein, the combustion gas 266 is generated using fuel and air that is not consumed by the fuel cells inside the housing 250 of the first fuel cell stack 232. The combustion gas 266 is provided to the combustion chamber 228 and burned during operation to generate combustion gasses used to generate thrust for the gas turbine engine 100 (and vehicle/aircraft incorporating the gas turbine engine 100).

The fuel and air inlet side 256 includes one or more fuel inlets 268 and one or more air inlets 270. Optionally, one or more of the inlets 268, 270 can be on another side of the housing 250. Each of the one or more fuel inlets 268 is fluidly coupled with a source of fuel for the first fuel cell stack 232, such as one or more pressurized containers of a hydrogen-containing gas or a fuel processing unit as described further below. Each of the one or more air inlets 270 is fluidly coupled with a source of air for the fuel cells, such as air that is discharged from a compressor section and/or an air processing unit as is also described further below. The one or more inlets 268, 270 separately receive the fuel and air from the external sources of fuel and air, and separately direct the fuel and air into the fuel cells.

In certain exemplary embodiments, the first fuel cell stack 232 of FIGS. 2 through 4 may be configured in a similar manner to one or more of the exemplary fuel cell systems (labeled 100) described in, e.g., U.S. Patent Application Publication No. 2020/0194799 A1, filed Dec. 17, 2018, that is incorporated by reference herein in its entirety. It will further be appreciated that the second fuel cell stack 234 of FIG. 2 may be configured in a similar manner as the first fuel cell stack 232, or alternatively may be configured in any other suitable manner.

Moreover, referring briefly back to FIG. 2, as will be explained in more detail below, the fuel cell assembly 204 may be controlled to provide certain results within the combustion chamber 228, e.g., to reduce combustion dynamics. For example, although the fuel cell assembly 204 is depicted as including a single fuel cell stack on the outer liner 210 along the axial direction A, in certain embodiments the first fuel cell stack 232 may in fact be a forward fuel cell stack 232A and an aft fuel cell stack 232B. The forward and aft fuel cell stacks 232A, 232B may be arranged sequentially along the axial direction A along the outer liner 210, and further may be controlled independently of one another (e.g., varying fuel to air ratios, fuel and air flowrates, power extraction, etc. between the two). In such a manner, output products from the forward fuel cell stack 232A provided at a first, forward location may be varied relative to output products from the aft fuel cell stack 232B provided at a second, aft location.

Similarly, referring back briefly to FIG. 3, the first fuel cell stack 232 may include circumferentially arranged fuel cell stacks 232C, 232D, arranged sequentially along the circumferential direction C along the outer liner 210. The circumferentially arranged fuel cell stacks 232C, 232D may also be controlled independently of one another (e.g., varying fuel to air ratios, fuel and air flowrates, power extraction, etc. between the two). In such a manner, output products from the fuel cell stack 232C provided at a first circumferential location may be varied relative to output products from the fuel cell stack 232D provided at a second circumferential location.

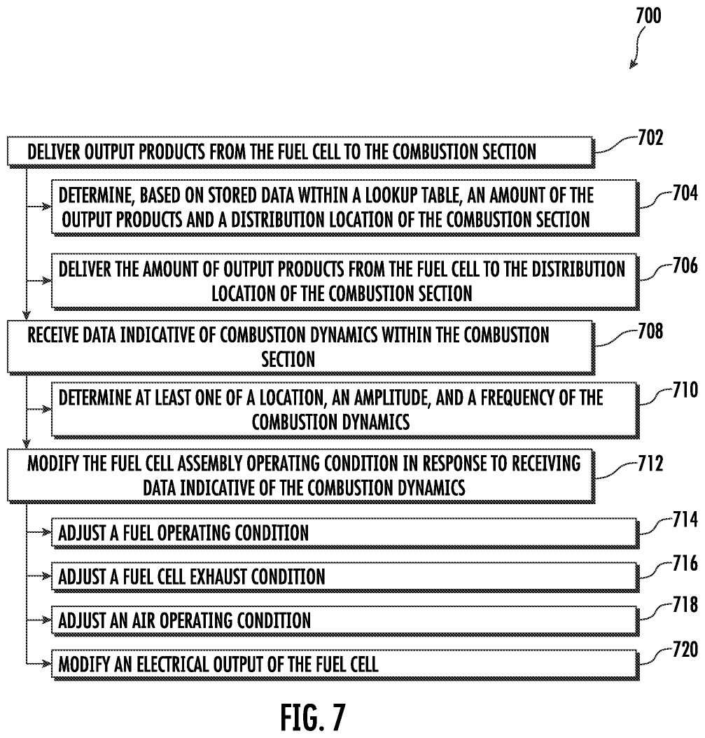

One or more of these configurations, as will be explained in more detail below with reference, e.g., to FIG. 7, may help mitigate combustion dynamics during operation.

Referring now to FIG. 5, operation of an integrated fuel cell and combustor assembly 200 in accordance with an exemplary embodiment of the present disclosure will be described. More specifically, FIG. 5 provides a schematic illustration of a gas turbine engine 100 and an integrated fuel cell and combustor assembly 200 according to an embodiment of the present disclosure. The gas turbine engine 100 and integrated fuel cell and combustor assembly 200 may, in certain exemplary embodiments, be configured in a similar manner as one or more of the exemplary embodiments of FIGS. 1 through 4.

Accordingly, it will be appreciated that the gas turbine engine 100 generally includes a fan section 102 having a fan 126, an LP compressor 110, an HP compressor 112, a combustion section 114, an HP turbine 116, and an LP turbine 118. The combustion section 114 generally includes the integrated fuel cell and combustor assembly 200 having a combustor 206 and a fuel cell assembly 204.

A propulsion system including the gas turbine engine 100 further includes a fuel delivery system 146. The fuel delivery system 146 generally includes a fuel source 148 and one or more fuel delivery lines 150. The fuel source 148 may include a supply of fuel (e.g., a hydrocarbon fuel, including, e.g., a carbon-neutral fuel or synthetic hydrocarbons) for the gas turbine engine 100. In addition, it will be appreciated that the fuel delivery system 146 also includes a fuel pump 272 and a flow divider 274, and the one or more fuel delivery lines 150 include a first fuel delivery line 150A, a second fuel delivery line 150B, and a third fuel delivery line 150C. The flow divider 274 divides the fuel flow from the fuel source 148 and fuel pump 272 into a first fuel flow through the first fuel delivery line 150A to the fuel cell assembly 204, a second fuel flow through the second fuel delivery line 150B also to the fuel cell assembly 204 (and in particular to an air processing unit, described below), and a third fuel flow through a third fuel delivery line 150C to the combustor 206. The flow divider 274 may include a series of valves (not shown) to facilitate such dividing of the fuel flow from the fuel source 148, or alternatively may be of a fixed geometry. Additionally, for the embodiment shown, the fuel delivery system 146 includes a first fuel valve 151A associated with the first fuel delivery line 150A (e.g., for controlling the first fuel flow), a second fuel valve 151B associated with the second fuel delivery line 150B (e.g., for controlling the second fuel flow), and a third fuel valve 151C associated with the third fuel delivery line 150C (e.g., for controlling the third fuel flow).

The gas turbine engine 100 further includes a compressor bleed system and an airflow delivery system. More specifically, the compressor bleed system includes an LP bleed air duct 276 and an associated LP bleed air valve 278, an HP bleed air duct 280 and an associated HP bleed air valve 282, an HP exit air duct 284 and an associated HP exit air valve 286.

The gas turbine engine 100 further includes an air stream supply duct 288 (in airflow communication with an airflow supply 290) and an associated air valve 292, which is also in airflow communication with the airflow delivery system for providing compressed airflow to the fuel cell assembly 204 of the integrated fuel cell and combustor assembly 200. The airflow supply may be, e.g., a second gas turbine engine configured to provide a cross-bleed air, an auxiliary power unit (APU) configured to provide a bleed air, a ram air turbine (RAT), etc. The airflow supply may be complimentary to the compressor bleed system if the compressor air source is inadequate or unavailable.

The compressor bleed system (and air stream supply duct 288) is in airflow communication with airflow delivery system for providing compressed airflow to the fuel cell assembly 204, as will be explained in more detail below.

Referring still to FIG. 5, the fuel cell assembly 204 of the integrated fuel cell and combustor assembly 200 includes a fuel cell stack 294, which may be configured in a similar manner as, e.g., the first fuel cell stack 232 described above. The fuel cell stack 294 is depicted schematically as a single fuel cell having a cathode side 296, an anode side 298, and an electrolyte 300 positioned therebetween. As will generally be appreciated, the electrolyte 300 may, during operation, conduct negative oxygen ions from the cathode side 296 to the anode side 298 to generate an electric current and electric power.

Briefly, it will be appreciated that the fuel cell assembly 204 further includes a fuel cell sensor 302 configured to sense data indicative of a fuel cell assembly operating parameter, such as a temperature of the fuel cell stack 294 (e.g., of the cathode side 296 or anode side 298 of the fuel cell), a pressure within the fuel cell stack 294 (e.g., of within the cathode side 296 or anode side 298 of the fuel cell).

The anode side 298 may support electrochemical reactions that generate electricity. A fuel may be oxidized in the anode side 298 with oxygen ions received from the cathode side 296 via diffusion through the electrolyte 300. The reactions may create heat, steam, and electricity in the form of free electrons in the anode side 298, which may be used to supply power to an energy consuming device (such as the one or more additional electric devices 328 described below). The oxygen ions may be created via an oxygen reduction of a cathode oxidant using the electrons returning from the energy consuming device into the cathode side 296.

The cathode side 296 may be coupled to a source of the cathode oxidant, such as oxygen in the atmospheric air. The cathode oxidant is defined as the oxidant that is supplied to the cathode side 296 employed by the fuel cell system in generating electrical power. The cathode side 296 may be permeable to the oxygen ions received from the cathode oxidant.

The electrolyte 300 may be in communication with the anode side 298 and the cathode side 296. The electrolyte 300 may pass the oxygen ions from the cathode side 296 to the anode side 298, and may have little or no electrical conductivity, so as to prevent passage of the free electrons from the cathode side 296 to the anode side 298.

The anode side of a solid oxide fuel cell (such as the fuel cell stack 294) may be composed of a nickel/yttria-stabilized zirconia (Ni/YSZ) cermet. Nickel in the anode side serves as a catalyst for fuel oxidation and current conductor. During normal operation of the fuel cell stack 294, the operating temperature may be greater than or equal to about 700° C., and the nickel (Ni) in the anode remains in its reduced form due to the continuous supply of primarily hydrogen fuel gas.

The fuel cell stack 294 is disposed downstream of the LP compressor 110, the HP compressor 112, or both. Further, as will be appreciated from the description above with respect to FIG. 2, the fuel cell stack 294 may be coupled to or otherwise integrated with a liner of the combustor 206 (e.g., an inner liner 208 or an outer liner 210). In such a manner, the fuel cell stack 294 may also be arranged upstream of the combustion chamber 228 of the integrated fuel cell and combustor assembly 200, and further upstream of the HP turbine 116 and LP turbine 118.

As shown in FIG. 5, the fuel cell assembly 204 also includes a fuel processing unit 304 and an air processing unit 306. The fuel processing unit 304 may be any suitable structure for generating a hydrogen rich fuel stream. For example, the fuel processing unit 304 may include a fuel reformer or a catalytic partial oxidation convertor (CPOx) for developing the hydrogen rich fuel stream for the fuel cell stack 294. The air processing unit 306 may be any suitable structure for raising the temperature of air that is provided thereto to a temperature high enough to enable fuel cell temperature control (e.g., about 600° C. to about 800° C.). For example, in the embodiment depicted, the air processing unit includes a preburner system, operating based on a fuel flow through the second fuel delivery line 150B, configured for raising the temperature of the air through combustion, e.g., during transient conditions such as startup, shutdown and abnormal situations.

In the exemplary embodiment depicted, the fuel processing unit 304 and air processing unit 306 are manifolded together within a housing 308 to provide conditioned air and fuel to the fuel cell stack 294.

It should be appreciated, however, that the fuel processing unit 304 may additionally or alternatively include any suitable type of fuel reformer, such as an autothermal reformer and steam reformer that may need an additional stream of steam inlet with higher hydrogen composition at the reformer outlet stream. Additionally, or alternatively, still, the fuel processing unit 304 may include a reformer integrated with the fuel cell stack 294. Similarly, it should be appreciated that the air processing unit 306 of FIG. 5 could alternatively be a heat exchanger or another device for raising the temperature of the air provided thereto to a temperature high enough to enable fuel cell temperature control (e.g., about 600° C. to about 800° C.).

As mentioned above, the compressor bleed system (and air stream supply duct 288) is in airflow communication with airflow delivery system for providing compressed airflow to the fuel cell assembly 204. The airflow delivery system includes an anode airflow duct 310 and an associated anode airflow valve 312 for providing an airflow to the fuel processing unit 304, a cathode airflow duct 314 and associated cathode airflow valve 316 for providing an airflow to the air processing unit 306, and a cathode bypass air duct 318 and an associated cathode bypass air valve 320 for providing an airflow directly to the fuel cell stack 294 (or rather to the cathode side 296 of the fuel cell(s)). The fuel delivery system 146 is configured to provide the first flow of fuel through the first fuel delivery line 150A to the fuel processing unit 304, and the second flow of fuel through the second fuel delivery line 150B to the air processing unit 306 (e.g., as fuel for a preburner system, if provided).

The fuel cell stack 294 outputs the power produced as a fuel cell power output 322. Further, the fuel cell stack 294 directs a cathode air discharge and an anode fuel discharge (neither labeled for clarity purposes) into the combustion chamber 228 of the combustor 206.

In operation, the air processing unit 306 is configured to heat/cool a portion of the compressed air, incoming through the cathode airflow duct 314, to generate a processed air to be directed into the fuel cell stack 294 to facilitate the functioning of the fuel cell stack 294. The air processing unit 306 receives the second flow of fuel from the second fuel delivery line 150B and may, e.g., combust such second flow of fuel to heat the air received to a desired temperature (e.g., about 600° C. to about 800° C.) to facilitate the functioning of the fuel cell stack 294. The air processed by the air processing unit 306 is directed into the fuel cell stack 294. In an embodiment of the disclosure, as is depicted, the cathode bypass air duct 318 and the air processed by the air processing unit 306 may combine into a combined air stream to be fed into a cathode 552 of the fuel cell stack 294.

Further, as shown in the embodiment of FIG. 5, the first flow of fuel through the first fuel delivery line 150A is directed to the fuel processing unit 304 for developing a hydrogen rich fuel stream (e.g., optimizing a hydrogen content of a fuel stream), to also be fed into the fuel cell stack 294. As will be appreciated, and as discussed below, the flow of air (processed air and bypass air) to the fuel cell stack 294 (e.g., the cathode side 296) and fuel from the fuel processing unit 304 to the fuel cell stack 294 (e.g., the anode side 298) may facilitate electrical power generation.

Because the inlet air for the fuel cell stack 294 may come solely from the upstream compressor section without any other separately controlled air source, it will be appreciated that the inlet air for the fuel cell stack 294 discharged from the compressor section is subject to the air temperature changes that occur at different flight stages. By way of illustrative example only, the air within a particular location in the compressor section of the gas turbine engine 100 may work at 200° C. during idle, 600° C. during take-off, 268° C. during cruise, etc. This type of temperature change to the inlet air directed to the fuel cell stack 294 may lead to significant thermal transient issues (or even thermal shock) to the ceramic materials of the fuel cell stack 294, which could range from cracking to failure.

Thus, by fluidly connecting the air processing unit 306 between the compressor section and the fuel cell stack 294, the air processing unit 306 may serve as a control device or system to maintain the air processed by the air processing unit 306 and directed into the fuel cell stack 294 within a desired operating temperature range (e.g., plus or minus 100° C., or preferably plus or minus 50° C., or plus or minus 20° C.). In operation, the temperature of the air that is provided to the fuel cell stack 294 can be controlled (relative to a temperature of the air discharged from the compressor section) by controlling the flow of fuel to the air processing unit 306. By increasing a fuel flow to the air processing unit 306, a temperature of the airflow to the fuel cell stack 294 may be increased. By decreasing the fuel flow to the air processing unit 306, a temperature of the airflow to the fuel cell stack 294 may be decreased. Optionally, no fuel can be delivered to the air processing unit 306 to prevent the air processing unit 306 from increasing and/or decreasing the temperature of the air that is discharged from the compressor section and directed into the air processing unit 306.

Moreover, as is depicted in phantom, the fuel cell assembly 204 further includes an airflow bypass duct 321 extending around the fuel cell 294 to allow a portion or all of an airflow conditioned by the air processing unit 306 (and combined with any bypass air through duct 318) to bypass the cathode side 296 of the fuel cell 294 and go directly to the combustion chamber 228. The airflow bypass duct 321 may be in thermal communication with the fuel cell 294. The fuel cell assembly further includes a fuel bypass duct 323 extending around the fuel cell 294 to allow a portion or all of a reformed fuel from the fuel processing unit 304 to bypass the anode side 298 of the fuel cell 294 and go directly to the combustion chamber 228.

As briefly mentioned above, the fuel cell stack 294 converts the anode fuel stream from the fuel processing unit 304 and air processed by the air processing unit 306 sent into the fuel cell stack 294 into electrical energy, the fuel cell power output 322, in the form of DC current. This fuel cell power output 322 is directed to a power convertor 324 in order to change the DC current into DC current or AC current that can be effectively utilized by one or more subsystems. In particular, for the embodiment depicted, the electrical power is provided from the power converter to an electric bus 326. The electric bus 326 may be an electric bus dedicated to the gas turbine engine 100, an electric bus of an aircraft incorporating the gas turbine engine 100, or a combination thereof. The electric bus 326 is in electric communication with one or more additional electrical devices 328, which may be adapted to draw an electric current from, or apply an electrical load to, the fuel cell stack 294. The one or more additional electrical devices 328 may be a power source, a power sink, or both. For example, the additional electrical devices 328 may be a power storage device (such as one or more batteries), an electric machine (an electric generator, an electric motor, or both), an electric propulsion device, etc. For example, the one or more additional electric devices 328 may include the starter motor/generator of the gas turbine engine 100.

Referring still to FIG. 5, the gas turbine engine 100 further includes a sensor 330 (which may be the one or more sensors 209 shown in FIG. 2 or may be a different sensor). In the embodiment shown, the sensor 330 is configured to sense data indicative of a combustion dynamics within the combustion section 114 of the gas turbine engine 100. For example, the sensor 330 may be configured to sense data indicative of fluctuations in pressure, heat-release rate, and/or disturbances in a flow of combustion gases. The sensor 330 may be, for example, a dynamics pressure sensor configured to sense data indicative of pressure within the combustion section 114. Additionally, or alternatively, the sensor 330 may be a temperature sensor configured to sense data indicative of a temperature within the combustion section, an exit temperature of the combustor, an inlet temperature of the turbine section, an exhaust gas temperature, or a combination thereof. In some embodiments, the sensor 330 may be a flow sensor configured to sense data indicative of a flowrate of combustion gases within the combustion section. In other embodiments, the sensor 330 may be any other suitable sensor, or any suitable combination of sensors, configured to sense one or more gas turbine engine operating conditions or parameters, including data indicative of combustion dynamics, such as fluctuations in pressure, heat-release rate, and/or disturbances in a flow of combustion gases within the combustion section 114 of the gas turbine engine 100.

Moreover, as is further depicted schematically in FIG. 5, the propulsion system, an aircraft including the propulsion system, or both, includes a controller 240. For example, the controller 240 may be a standalone controller, a gas turbine engine controller (e.g., a full authority digital engine control, or FADEC, controller), an aircraft controller, supervisory controller for a propulsion system, a combination thereof, etc.

The controller 240 is operably connected to the various sensors, valves, etc. within at least one of the gas turbine engine 100 and the fuel delivery system 146. More specifically, for the exemplary aspect depicted, the controller 240 is operably connected to the valves of the compressor bleed system (valves 278, 282, 286), the airflow delivery system (valves 312, 316, 320), and the fuel delivery system 146 (flow divider 274, valves 151A, 151B, 151C), as well as a sensor 330 of the gas turbine engine 100 and the fuel cell sensor 302. As will be appreciated from the description below, the controller 240 may be in wired or wireless communication with these components. In this manner, the controller 240 may receive data from a variety of inputs (including the gas turbine engine sensor 330 and the fuel cell sensor 302), may make control decisions, and may provide data (e.g., instructions) to a variety of output (including the valves of the compressor bleed system to control an airflow bleed from the compressor section, the airflow delivery system to direct the airflow bled from the compressor section, and the fuel delivery system 146 to direct the fuel flow within the gas turbine engine 100).

Referring particularly to the operation of the controller 240, in at least certain embodiments, the controller 240 can include one or more computing device(s) 332. The computing device(s) 332 can include one or more processor(s) 332A and one or more memory device(s) 332B. The one or more processor(s) 332A can include any suitable processing device, such as a microprocessor, microcontroller, integrated circuit, logic device, and/or other suitable processing device. The one or more memory device(s) 332B can include one or more computer-readable media, including, but not limited to, non-transitory computer-readable media, RAM, ROM, hard drives, flash drives, and/or other memory devices.

The one or more memory device(s) 332B can store information accessible by the one or more processor(s) 332A, including computer-readable instructions 332C that can be executed by the one or more processor(s) 332A. The instructions 332C can be any set of instructions that when executed by the one or more processor(s) 332A, cause the one or more processor(s) 332A to perform operations. In some embodiments, the instructions 332C can be executed by the one or more processor(s) 332A to cause the one or more processor(s) 332A to perform operations, such as any of the operations and functions for which the controller 240 and/or the computing device(s) 332 are configured, the operations for operating a propulsion system (e.g., method 700), as described herein, and/or any other operations or functions of the one or more computing device(s) 332. The instructions 332C can be software written in any suitable programming language or can be implemented in hardware. Additionally, and/or alternatively, the instructions 332C can be executed in logically and/or virtually separate threads on processor(s) 332A. The memory device(s) 332B can further store data 332D that can be accessed by the processor(s) 332A. For example, the data 332D can include data indicative of power flows, data indicative of gas turbine engine 100/aircraft operating conditions, and/or any other data and/or information described herein.

The computing device(s) 332 also includes a network interface 332E configured to communicate, for example, with the other components of the gas turbine engine 100 (such as the valves of the compressor bleed system (valves 278, 282, 286), the airflow delivery system (valves 312, 316, 320), and the fuel delivery system 146 (flow divider 274, valves 151A, 151B, 151C), as well as the sensor 330 of the gas turbine engine 100 and the fuel cell sensor 302), the aircraft incorporating the gas turbine engine 100, etc. The network interface 332E can include any suitable components for interfacing with one or more network(s), including for example, transmitters, receivers, ports, controllers, antennas, and/or other suitable components. In such a manner, it will be appreciated that the network interface 332E may utilize any suitable combination of wired and wireless communications network(s).

The technology discussed herein makes reference to computer-based systems and actions taken by and information sent to and from computer-based systems. It will be appreciated that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

It will be appreciated that the gas turbine engine 100, the exemplary fuel delivery system 146, the exemplary integrated fuel cell and combustor assembly 200, and the exemplary fuel cell assembly 204 are provided by way of example only. In other embodiments, the integrated fuel cell and combustor assembly 200 and fuel cell assembly 204 may have any other suitable configuration. For example, in other exemplary embodiments, the fuel cell assembly 204 may include any other suitable fuel processing unit 304. Additionally, or alternatively, the fuel cell assembly 204 may not require a fuel processing unit 304, e.g., when the combustor of the gas turbine engine 100 is configured to burn hydrogen fuel and the fuel delivery assembly 146 is configured to provide hydrogen fuel to the integrated fuel cell and combustor assembly 200, and in particular to the fuel cell assembly 204.

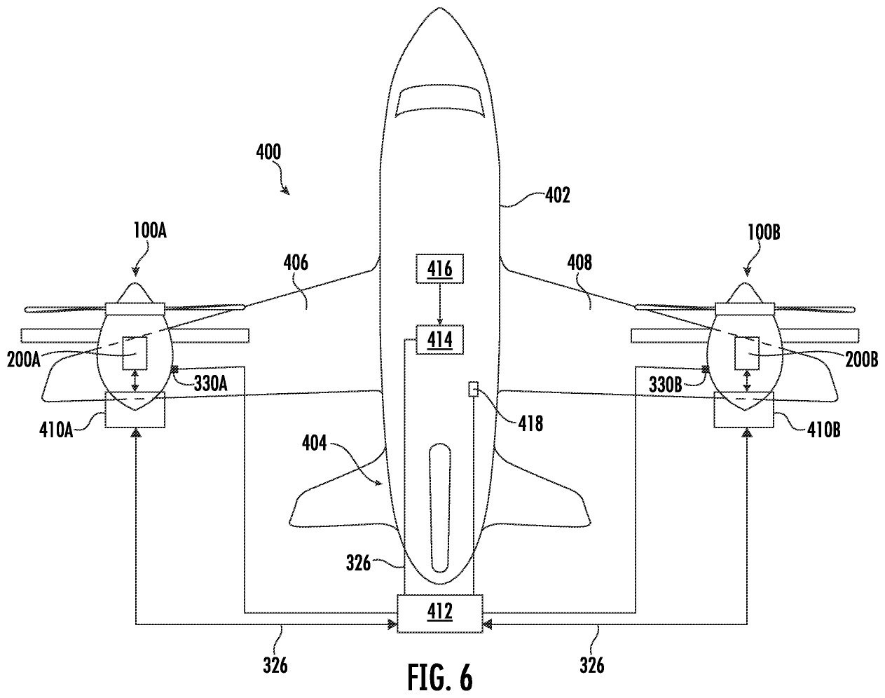

As briefly mentioned above, the fuel cell assembly 204 may be in electrical communication with the electric bus 326, which may be an electric bus of the gas turbine engine 100, of an aircraft, or a combination thereof. Referring now briefly to FIG. 6, a schematic view is provided of an aircraft 400 in accordance with an embodiment of the present disclosure including one or more gas turbine engines 100 (labeled 100A and 100B), each with an integrated fuel cell and combustor assembly 200 (labeled 200A and 200B), and an aircraft electric bus 326 in electrical communication with the one or more gas turbine engines 100.

In particular, for the exemplary embodiment depicted, the aircraft 400 is provided including a fuselage 402, an empennage 404, a first wing 406, a second wing 408, and a propulsion system. The propulsion system generally includes a first gas turbine engine 100A coupled to, or integrated with, the first wing 406 and a second gas turbine engine 100B coupled to, or integrated with, the second wing 408. It will be appreciated, however, that in other embodiments, any other suitable number and or configuration of gas turbine engines 100 may be provided (e.g., fuselage-mounted, empennage-mounted, etc.).

The first gas turbine engine 100A generally includes a first integrated fuel cell and combustor assembly 200A and a first electric machine 410A. The first integrated fuel cell and combustor assembly 200A may generally include a first fuel cell assembly. The first electric machine 410A may be an embedded electric machine, an offset electric machine (e.g., rotatable with the gas turbine engine 100 through an accessory gearbox or suitable geartrain), etc. For example, in certain exemplary embodiments, the first electric machine 410A may be a starter motor/generator for the first gas turbine engine 100A.

Similarly, the second gas turbine engine 100B generally includes a second integrated fuel cell and combustor assembly 200B and a second electric machine 410B. The second integrated fuel cell and combustor assembly 200B may generally include a second fuel cell assembly. The second electric machine 410B may also be an embedded electric machine, an offset electric machine (e.g., rotatable with the gas turbine engine 100 through an accessory gearbox or suitable geartrain), etc. For example, in certain exemplary embodiments, the second electric machine 410B may be a starter motor/generator for the second gas turbine engine 100B.

In the embodiment of FIG. 6, the aircraft 400 additionally includes the electric bus 326 and a supervisory controller 412. Further, it will be appreciated that the aircraft 400 and/or propulsion system includes one or more electric devices 414 and an electric energy storage unit 416, each in electric communication with the electric bus 326. The electric devices 414 may represent one or more aircraft power loads (e.g., avionics systems, control systems, electric propulsors, etc.), one or more electric power sources (e.g., an auxiliary power unit), etc. The electric energy storage unit 416 may be, e.g., a battery pack or the like for storing electric power.

The electric bus 326 further electrically connects to the first electric machine 410A and first fuel cell assembly, as well as to the second electric machine 410B and second fuel cell assembly. The supervisory controller 412 may be configured in a similar manner as the controller 240 of FIG. 5 or may be in operative communication with a first gas turbine engine controller dedicated to the first gas turbine engine 100A and a second gas turbine engine controller dedicated to the second gas turbine engine 100B.

In such a manner, it will be appreciated that the supervisory controller 412 may be configured to receive data from a gas turbine engine sensor 330A of the first gas turbine engine 100A and from a gas turbine engine sensor 330B of the second gas turbine engine 100B, and may further be configured to send data (e.g., commands) to various control elements (such as valves) of the first and second gas turbine engines 100A, 100B.

Moreover, it will be appreciated that for the embodiment depicted, the aircraft 400 includes one or more aircraft sensor(s) 418 configured to sense data indicative of various flight operations of the aircraft 400, including, e.g., altitude, ambient temperature, ambient pressure, airflow speed, etc. The supervisory controller 412 is operably connected to these aircraft sensor(s) 418 to receive data from such aircraft sensor(s) 418.

In addition to receiving data from sensors 330A, 330B, 418 and sending data to control elements, the supervisory controller 412 is configured to control a flow of electric power through the electric bus 326. For example, the supervisory controller 412 may be configured to command and receive a desired power extraction from one or more of the electric machines (e.g., the first electric machine 410A and second electric machine 410B), one or more of the fuel cell assemblies (e.g., the first fuel cell assembly and second fuel cell assembly), or both, and provide all or a portion of the extracted electric power to other of the one or more of the electric machines (e.g., the first electric machine 410A and second electric machine 410B), one or more of the fuel cell assemblies (e.g., the first fuel cell assembly and second fuel cell assembly), or both. One or more of these actions may be taken in accordance with the logic outlined below.

Referring back generally to FIGS. 1 through 5, occasionally during a flight operation of the gas turbine engine 100, the combustion section may experience fluctuations in pressure, heat-release rate, and/or a flow of combustion gases commonly referred to as “combustion dynamics.” Such may be the result of interaction between heat release from combusting fuel-air mixture and pressure oscillations in the combustion chamber 228. The combustion dynamic pressure waves may range in frequency from a few hertz to a few thousand hertz. Combustion dynamics may be in the form of fluctuations in pressure, heat-release rate, and other perturbations in flow outside of nominal or steady-state operating conditions of the combustion section.

As mentioned, the present disclosure generally relates to a gas turbine engine incorporating an integrated fuel cell and combustor assembly having a fuel cell assembly. The inventors of the present disclosure have discovered that certain operations of the fuel cell assembly may have a downstream effect on various parameters which may advantageously assist with the mitigation, prevention, and/or elimination of combustion dynamics within the combustion section of the gas turbine engine.

For example, referring now to FIG. 7, a flow diagram of a method for operating a propulsion system for an aircraft, or more specifically, a method 700 for mitigating combustion dynamics within a combustion section, is provided. In certain exemplary aspects, the method 700 may be used with one or more of the exemplary integrated fuel cell and combustor assemblies 200 having a fuel cell assembly 204, gas turbine engines 100, and/or aircraft described above with respect to FIGS. 1 through 6. Additionally, or alternatively, the method 700 may be used with any other suitable integrated fuel cell and combustor assemblies having a fuel cell assembly, gas turbine engines, and/or aircraft.

Accordingly, it will be appreciated that the method 700 may be utilized with a propulsion system for an aircraft. The aircraft may generally include an aircraft fuel supply. The propulsion system may generally include a gas turbine engine with an integrated fuel cell and combustor assembly and a turbomachine. The integrated fuel cell and combustor assembly may generally include a fuel cell, a fuel processing unit (having, e.g., a fuel reformer), and an air processing unit (having, e.g., a preburner system). The fuel cell may define an outlet positioned to remove output products from the fuel cell. The turbomachine may generally include a compressor section, a combustion section, and a turbine section arranged in serial flow order. The combustion section is configured to receive a flow of aviation fuel from the aircraft fuel supply and is further configured to receive the output products from the fuel cell.

The method 700 includes delivering the output products from the fuel cell to the combustion section, and more specifically includes at (702) delivering the output products from the fuel cell to the combustion section to mitigate combustion dynamics within the combustion section. Delivering at (702) may be based at least partially on stored data (e.g., within the memory device 332B of the controller 240). For example, the output products of the fuel cell may be delivered to the combustion section in accordance with stored data in the form of a lookup table, such as a schedule, chart, table of data, or the like for a given input parameter. Such may be an open-loop control approach to mitigating combustion dynamics within the combustion section. In particular, the open-loop control approach to combating, suppressing, or mitigating combustion dynamics does not require that the controller receive an indication of unstable combustion dynamics (e.g., via a sensor), but rather that the controller determines an amount, composition, and/or location of output products to deliver from the fuel cell to the combustion section according to a predetermined value in a lookup table for a given operating condition or parameter, which may or may not be based on a variety of factors or inputs.

In some embodiments, the method 700 may include at (704) determining, based on stored data within a lookup table, an amount of the output products and a distribution location of the output products in the combustion section. Determining at (704) may include identifying and/or selecting the amount of output products and the distribution location as output parameters from the lookup table based on one or more corresponding input parameters (e.g., engine operating condition, fuel cell assembly operating condition, aircraft operating condition, etc., such as such as flight speed, Mach number, altitude, flight modes, combustion section temperature, combustion section pressure, engine speed, or other input parameters). For example, determining at (704) may include receiving data indicative of the one or more input parameters of the engine, propulsion system, and/or aircraft to identify the corresponding output parameters of the fuel cell in the lookup table. For example, the input parameters may include altitude, flight speed, Mach number, ambient temperature, ambient pressure, airflow speed, combustion section temperature, exhaust temperature, combustion section pressure or other suitable input parameters. In exemplary embodiments, the one or more input parameters may be indicative of combustion dynamics within the combustion section. Based on one or more of the input parameters, the controller may identify or determine a corresponding output parameter of the fuel cell in the lookup table, such as an amount, fuel composition, and/or distribution location of output products to deliver to the combustion section from the fuel cell. The distribution location may include a distribution along the axial direction, along the circumferential direction, or both. Subsequently, the method 700 may include at (706) delivering the determined amount of output products from the fuel cell to the determined distribution location of the combustion section.

Referring briefly back to FIGS. 2 and 4, both the first fuel cell stack 232 and the second fuel cell stack 234 include a plurality of fuel cells that are “stacked,” e.g., side-by-side. Each fuel cell in the first fuel cell stack 232 and in the second fuel cell stack 234 defines an outlet 235 positioned at a respective location along the combustion section 114 to remove output products from the respective fuel cell to the respective location. More particularly, the outlet 235 of each fuel cell may be disposed at a respective location along the inner or outer liner 208, 210 and in fluid communication with the combustion chamber 228. For example, the outlet 235 of each fuel cell in the first fuel cell stack 232 may be disposed at a respective location along the outer liner 210 and in fluid communication with the combustion chamber 228. Similarly, the outlet 235 of each fuel cell in the second fuel cell stack 234 may be disposed at a respective location along the inner liner 208 and in fluid communication with the combustion chamber 228. The outlets 235 of each fuel cell in both the first fuel cell stack 232 and the second fuel cell stack 234 may be spaced apart from one another both axially and circumferentially, which advantageously allows for a spaced distribution of fuel cell output products within the combustion chamber 228. In other words, the spaced distribution of outlets 235 along the inner and outer liners 208, 210 advantageously allows the output products of the fuel cells to be delivered to a variety of locations within the combustion chamber 228 as necessary to combat or mitigate combustion dynamics.

As discussed above, the fuel cell assembly may include a fuel cell stack having a plurality of fuel cells each defining an outlet positioned at a respective location along the combustion section to remove output products from the respective fuel cell to the respective location. In such embodiments, referring back to FIG. 7, delivering at (702) may include distributing the output products to one or more of the respective locations to mitigate the combustion dynamics. For example, the output products may be distributed (or selectively delivered) to any one of the outlets 235 in the fuel cell assembly. In exemplary embodiments, as shown in FIGS. 2 through 4, the outlet 235 of each fuel cell may be spaced apart from a neighboring outlet 235 of a neighboring fuel cell in at least one of the axial direction A or a circumferential direction C. In this way, delivering at (702) may include providing the output products to one or more of the outlets, such that the output products may be distributed within the combustion chamber as necessary to suppress combustion dynamics.

More specifically, it will be appreciated that providing output products through the outlets 235 of the fuel cells in the first fuel cell stack 232 and the second fuel cell stack 234 to the combustion chamber 228 having varied parameters (amounts, compositions, temperatures, pressures, etc.) along the axial direction A and/or the circumferential direction C may include controlling the first fuel cell stack 232 and the second fuel cell stack 234, respectively. Alternatively, with respect to achieving output products having varied parameters along the axial direction A, as may be specified by the distribution location, such may achieved by controlling the forward fuel cell stack 232A relative to the aft fuel cell stack 232B such that the output products of the forward fuel cell stack 232A has varied parameters relative to the output products of the aft fuel cell stack 232B. Similarly, with respect to achieving output products having varied parameters along the circumferential direction C, as may also be specified by the distribution location, such may achieved by controlling the first circumferential fuel cell stack 232C relative to the second circumferential fuel cell stack 232D such that the output products of the first circumferential fuel cell stack 232C has varied parameters relative to the output products of the second circumferential fuel cell stack 232D.

In many embodiments, mitigating combustion dynamics within the combustion section may be based on a closed loop control approach, in which the controller may utilize one or more sensed inputs from the combustion section to determine an amount, composition, and/or optimal delivery location of the output products within the combustion chamber to mitigate combustion dynamics. In such embodiments, the method 700 may further include at (708) receiving data indicative of combustion dynamics within the combustion section. For example, receiving data at (708) may be via the one or more sensors 209. The one or more sensors 209 may be in operable communication with the controller 240 and may be configured to sense data indicative of fluctuations in pressure, heat-release rate, and/or in a flow rate of combustion gases (i.e., combustion dynamics) within the combustion chamber 228. Particularly, the one or more sensors 209 may each be a dynamics pressure sensor configured to sense data indicative of fluctuations, pulses, or oscillations in pressure within the combustion chamber 228.

In exemplary implementations, in addition to receiving data indicative of the combustion dynamics within the combustor, the controller may determine the severity and location of the combustion dynamics within the combustion section based at least partially on the data received. In such embodiments, receiving data at (708) may further include at (710) determining at least one of a location, an amplitude, and/or a frequency of the combustion dynamics. For example, the controller may determine the amplitude and/or the frequency of the pulses in pressure, heat-release rate, and/or flow rate. Additionally, or alternatively, the controller may determine a location of the combustion dynamics within the combustion chamber, e.g., relative to other components of the combustion section. For example, the controller may determine, based on data received (e.g., via sensors 209), that the combustion dynamics are occurring closer to the inner liner 208 than the outer liner 210 (or vice versa). Similarly, the controller may determine, based on data received (e.g., via sensors 209), that the combustion dynamics are occurring closer to an outlet of the combustion chamber 228 than the dome assembly 212 (or vice versa). In this way, the controller may determine, based on data received (e.g., from sensor 209), the precise location, amplitude, and frequency of the combustion dynamics within the combustion chamber 228, such that a corresponding modification may be made to the fuel cell assembly operating condition or output product distribution to address the combustion dynamics.

The fuel cell assembly defines a fuel cell assembly operating condition. The method 700 may include at (712) modifying the fuel cell assembly operating condition in response to receiving data indicative of the combustion dynamics within the combustion section to mitigate the combustion dynamics. Modifying the fuel cell assembly operating condition at (712) may be based at least partially on the determined amplitude, frequency, and/or location of the combustion dynamics within the combustion section. For example, once the controller has determined data indicative of combustion dynamics within the combustion section, which may include the amplitude, frequency, and/or location of the combustion dynamics, the controller may modify the fuel cell assembly operating condition in response to mitigate the combustion dynamics within the combustion section. As will be appreciated, and as will be discussed below, the fuel cell assembly operating condition may be at least one of a fuel operating condition, an air operating condition, a fuel cell exhaust condition, or a fuel cell operating condition.

In many embodiments, modifying the fuel cell assembly operating condition at (712) may include at (714) adjusting a fuel operating condition of the fuel cell assembly. The fuel operating condition may include, e.g., a reformed fuel flowrate to the fuel cell, a bypass ratio of reformed fuel around a stack (the stack including a stack of fuel cells, including the fuel cell previously mentioned) to the combustion chamber, a reformation or conversion rate of a fuel flow through the fuel conditioning unit, a fuel temperature (e.g., a peak fuel temperature in the fuel processing unit or an exit temperature of the fuel from the fuel processing unit (each affecting fuel composition to the fuel cell stack)), a fuel temperature downstream of a fuel heat exchanger (e.g., thermally coupled to an engine accessory system, such as a lubrication oil system), a fuel to air ratio in the fuel processing unit, a fuel processing unit gas hourly space velocity (total gas flowrate), etc. Increasing the reformed fuel flowrate to the fuel cell may increase a fuel to air ratio in the output products provided to the combustion chamber, as there may be more hydrogen gas (H₂) than oxygen electrons in the airflow provided to the fuel cell, such that more H₂ passes through the stack unconverted to water (H₂O). This may result in an increase of an overall fuel to air ratio in the combustion chamber. Similarly, increasing a bypass ratio of reformed fuel around the stack of fuel cells to the combustion chamber may also increase an overall fuel to air ratio in the combustion chamber.

In exemplary embodiments, modifying the fuel cell operating condition at (712) may include at (716) adjusting a fuel cell exhaust condition of the fuel cell assembly. The fuel cell exhaust condition may include, e.g., fuel cell assembly output product compositions (e.g., an H₂%, a CO %, a CO₂%, an H₂O %, a CH₄%, and/or an N₂% in the anode, and an O₂%, and/or an N₂% in the cathode), a fuel cell assembly output product total flowrate, a fuel cell assembly output product air/fuel flowrate ratio, a fuel cell assembly output product temperature, and a fuel cell assembly output product velocity. In such a manner, modifying the fuel cell assembly operating condition at (712) may include modifying one or more of these parameters.

In various embodiments, modifying the fuel cell assembly operating condition at (712) may include at (718) adjusting an air operating condition of the fuel cell assembly. The air operating condition may include, e.g., an air flowrate to the fuel cell, a bypass ratio of air flow around the fuel cell (and around the stack), a volume of airflow received by the air processing unit of the fuel cell assembly (which may be directly tied to a bleed air rate within the combustion section of the gas turbine engine), an amount of fuel provided to the air processing unit (e.g., the preburner), an amount of fuel in the airflow from the air processing unit (e.g., unburned preburner fuel provided from second fuel delivery line 150B), a temperature of the airflow from the air processing unit, an airflow inlet temperature to the fuel cell stack, etc. These air operating conditions may similarly affect an overall fuel to air ratio in the output products to the combustion chamber (and/or in the combustion chamber directly), depending on any changes to the fuel operating condition. In such a manner, it will be appreciated that in certain exemplary aspects, modifying the fuel cell assembly operating condition at (712) may include at modifying an airflow to the fuel cell from the compressor section. For example, modifying at may include increasing or decreasing the airflow to the fuel cell from the compressor section.

The fuel operating condition, the air operating condition, or both may be modified to adjust a fuel to air ratio of the output products provided to the combustion chamber. In such a manner, modifying the fuel cell assembly operating condition at (712) may include adjusting a ratio of a flow of reformed fuel to the fuel cell to a flow of air to the fuel cell, e.g., to adjust a fuel to air ratio of the output products provided to the combustion chamber.

In particular embodiments, modifying the fuel cell assembly operating condition at (712) may include at (720) modifying (e.g., increasing or decreasing) an electrical output of the fuel cell. The fuel cell operating condition may include, e.g., a current drawn from the fuel cell. In such a manner, modifying the fuel cell assembly operating condition at (712) may include reducing an electrical output of the fuel cell, or alternatively may include increasing an electric load on the fuel cell.

Increasing the current drawn from the fuel cell may, e.g., result in more complete reaction between free oxygen in the airflow to the fuel cell and the hydrogen gas in the reformed fuel to the fuel cell, in turn resulting in a decrease in the fuel to air ratio of the output products provided to the combustion chamber. Such may further provide more electrical power to an electric bus of the gas turbine engine/aircraft, and may also increase a temperature of the output products provided to the combustion chamber (as the increased reaction generates heat). Accordingly, increasing an electrical power output from the fuel cell may further allow for reducing an electrical power output of an electric machine rotatable with a core of the gas turbine engine, in turn resulting in a reduced “drag load” on the gas turbine engine.

By contrast, decreasing a current drawn from the fuel cell (i.e., reducing the electrical output of the fuel cell) may, e.g., result in a less complete reaction between free oxygen in the airflow to the fuel cell and the hydrogen gas in the reformed fuel to the fuel cell, in turn resulting in an increase in the fuel to air ratio of the output products provided to the combustion chamber. Moreover, such may require an increased amount of power extraction from an electric machine rotatable with a core of the gas turbine engine, resulting in more drag on the core, slowing down the core of the gas turbine engine.

Each of these operating conditions may be modified to drive certain changes within the gas turbine engine, such as: a composition of the output products of the fuel cell (e.g., a percentage of H₂ within the output products, an overall fuel to air ratio of the output products, a temperature of the output products) and thus an overall composition within the combustion chamber (e.g., an overall fuel to air ratio in the combustion chamber, a percentage (e.g., a volume percentage) of H₂ within the combustion chamber, a temperature within the combustion chamber, a local fuel to air ratio within the combustion chamber (e.g., at the entrance), etc.); a rotational speed of the gas turbine engine (e.g., if more power is provided by the fuel cell assembly, less power may need to be extracted from an electric generator coupled to the gas turbine engine, or by inverse, if less power is provided by the fuel cell assembly, more power may need to be extracted from the electric generator coupled to the gas turbine engine—each affecting a drag on rotating components of the gas turbine engine and thus rotational speeds); etc. In such a manner, it will be appreciated that modifying the fuel cell assembly operating condition at (712) may include, e.g., increasing a fuel to air ratio within the combustion chamber, increasing a temperature within the combustion chamber, or both.

Notably, these changes in the gas turbine engine may in turn result in modifications to various factors that impact combustion dynamics within the combustion section of the gas turbine engine. For example, the change in the composition of the output products may drive an air to fuel ratio/equivalence ratio within the combustion chamber, may affect a temperature within the combustion chamber, may affect a fuel mix (e.g., percentage of hydrogen gas) within the combustion chamber, and may affect a residence time (e.g., total airflow) through the combustion chamber. Each of these relight factors may directly impact (e.g., combat, suppress, mitigate, or eliminate) combustion dynamics within the combustion section.

More specifically, it will be appreciated that by modifying the fuel cell assembly operating condition, or by modifying multiple fuel cell assembly operating conditions, changes within the combustion chamber may be driven to provide more favorable conditions for mitigating combustion dynamics.

Operation of a propulsion system in accordance with one or more of these exemplary aspects may advantageously mitigate combustion dynamics within the combustion section. This may advantageously provide for increased operation flexibility of the gas turbine engine and advantageously improve hardware life of the combustion section components.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A propulsion system for an aircraft, the aircraft comprising an aircraft fuel supply, the propulsion system comprising: a fuel cell assembly comprising a fuel cell, the fuel cell defining an outlet positioned to remove output products from the fuel cell and a fuel cell assembly operating condition; a turbomachine comprising a compressor section, a combustion section, and a turbine section arranged in serial flow order, the combustion section configured to receive a flow of aviation fuel from the aircraft fuel supply and further configured to receive the output products from the fuel cell; and a controller comprising memory and one or more processors, the memory storing instructions that when executed by the one or more processors cause the propulsion system to perform operations including: delivering the output products from the fuel cell to the combustion section to mitigate combustion dynamics within the combustion section.

The propulsion system of one or more of these clauses, wherein the memory further comprises a lookup table, and wherein delivering the output products from the fuel cell to the combustion section comprises: determining, based on stored data within the lookup table, an amount of the output products and a distribution location of the combustion section, delivering the amount of the output products from the fuel cell to the distribution location of the combustion section to mitigate the combustion dynamics within the combustion section.

The propulsion system of one or more of these clauses, wherein the fuel cell assembly comprises a fuel cell stack comprising a plurality of fuel cells each defining an outlet positioned at a respective location along the combustion section to remove output products from the respective fuel cell to the respective location, and wherein delivering the output products comprises distributing the output products to one or more of the respective locations to mitigate the combustion dynamics.

The propulsion system of one or more of these clauses, wherein the outlet of each fuel cell is spaced apart from a neighboring outlet of a neighboring fuel cell in at least one of an axial direction or a circumferential direction.

The propulsion system of one or more of these clauses, wherein the operations further comprise: receiving data indicative of combustion dynamics within the combustion section; and modifying the fuel cell assembly operating condition in response to receiving data indicative of the combustion dynamics within the combustion section to mitigate the combustion dynamics.

The propulsion system of one or more of these clauses, wherein receiving data indicative of combustion dynamics within the combustion section comprises determining at least one of a location, an amplitude, and a frequency of the combustion dynamics, and wherein the fuel cell assembly operating condition is modified based at least partially on one of the location, the amplitude, and the frequency of the combustion dynamics within the combustion section.

The propulsion system of one or more of these clauses, wherein modifying the fuel cell assembly operating condition comprises adjusting a fuel operating condition, wherein adjusting the fuel operating condition comprises adjusting a fuel to air ratio in the fuel processing unit, a fuel processing unit gas hourly space velocity (total gas flowrate), or a combination thereof.

The propulsion system of one or more of these clauses, wherein modifying the fuel cell assembly operating condition comprises adjusting a fuel cell exhaust condition, wherein the fuel cell exhaust condition includes at least one of a fuel cell assembly output product composition, a fuel cell assembly output product total flowrate, a fuel cell assembly output product air/fuel flowrate ratio, a fuel cell assembly output product temperature, and a fuel cell assembly output product velocity.

The propulsion system of one or more of these clauses, wherein modifying the fuel cell assembly operating condition comprises adjusting an air operating condition.

The propulsion system of one or more of these clauses, wherein modifying the fuel cell assembly operating condition comprises modifying an electrical output of the fuel cell.

A method of operating a propulsion system for an aircraft, the propulsion system comprising a fuel cell assembly comprising a fuel cell and defining a fuel cell assembly operating condition, the fuel cell defining an outlet positioned to remove output products from the fuel cell and a turbomachine, the turbomachine comprising a combustion section configured to receive a flow of aviation fuel from an aircraft fuel supply of the aircraft and further configured to receive the output products from the fuel cell, the method comprising: delivering the output products from the fuel cell to the combustion section to mitigate combustion dynamics within the combustion section.

The method of one or more of these clauses, wherein delivering the output products from the fuel cell to the combustion section comprises: determining, based on stored data within the lookup table, an amount of the output products and a distribution location of the combustion section, delivering the amount of the output products from the fuel cell to the distribution location of the combustion section to mitigate the combustion dynamics within the combustion section.

The method of one or more of these clauses, wherein the fuel cell assembly comprises a fuel cell stack comprising a plurality of fuel cells each defining an outlet positioned at a respective location along the combustion section to remove output products from the respective fuel cell to the respective location, and wherein delivering the output products comprises distributing the output products to one or more of the respective locations to mitigate the combustion dynamics.

The method of one or more of these clauses, wherein the outlet of each fuel cell is spaced apart from a neighboring outlet of a neighboring fuel cell in at least one of an axial direction or a circumferential direction.

The method of one or more of these clauses, further comprising:

receiving data indicative of combustion dynamics within the combustion section; and modifying the fuel cell assembly operating condition in response to receiving data indicative of the combustion dynamics within the combustion section to mitigate the combustion dynamics.

The method of one or more of these clauses, wherein receiving data indicative of combustion dynamics within the combustion section comprises determining at least one of a location, an amplitude, and a frequency of the combustion dynamics, and wherein the fuel cell assembly operating condition is modified based at least partially on one of the location, the amplitude, and the frequency of the combustion dynamics within the combustion section.

The method of one or more of these clauses, wherein modifying the fuel cell assembly operating condition comprises adjusting a fuel operating condition, wherein adjusting the fuel operating condition comprises adjusting a fuel to air ratio in the fuel processing unit, a fuel processing unit gas hourly space velocity (total gas flowrate), or a combination thereof.

The method of one or more of these clauses, wherein modifying the fuel cell assembly operating condition comprises adjusting a fuel cell exhaust condition, wherein the fuel cell exhaust condition includes at least one of a fuel cell assembly output product composition, a fuel cell assembly output product total flowrate, a fuel cell assembly output product air/fuel flowrate ratio, a fuel cell assembly output product temperature, and a fuel cell assembly output product velocity.

The method of one or more of these clauses, wherein modifying the fuel cell assembly operating condition comprises adjusting an air operating condition.

The method of one or more of these clauses, wherein modifying the fuel cell assembly operating condition comprises modifying an electrical output of the fuel cell.

We claim:

1. A propulsion system for an aircraft, the aircraft comprising an aircraft fuel supply, the propulsion system comprising:
a fuel cell assembly comprising a fuel cell, the fuel cell defining an outlet positioned to remove output products from the fuel cell and a fuel cell assembly operating condition;
a turbomachine comprising a compressor section, a combustion section, and a turbine section arranged in serial flow order, the combustion section configured to receive a flow of aviation fuel from the aircraft fuel supply and further configured to receive the output products from the fuel cell; and
a controller comprising memory and one or more processors, the memory storing instructions that when executed by the one or more processors cause the propulsion system to perform operations including:
delivering the output products from the fuel cell to the combustion section to mitigate combustion dynamics within the combustion section.

2. The propulsion system of claim 1, wherein the memory further comprises a lookup table, and wherein delivering the output products from the fuel cell to the combustion section comprises:
determining, based on stored data within the lookup table, an amount of the output products and a distribution location of the combustion section,
delivering the amount of the output products from the fuel cell to the distribution location of the combustion section to mitigate the combustion dynamics within the combustion section.

3. The propulsion system of claim 1, wherein the fuel cell assembly comprises a fuel cell stack comprising a plurality of fuel cells each defining an outlet positioned at a respective location along the combustion section to remove output products from the respective fuel cell to the respective location, and wherein delivering the output products comprises distributing the output products to one or more of the respective locations to mitigate the combustion dynamics.

4. The propulsion system of claim 3, wherein the outlet of each fuel cell is spaced apart from a neighboring outlet of a neighboring fuel cell in at least one of an axial direction or a circumferential direction.

5. The propulsion system of claim 1, wherein the operations further comprise:
receiving data indicative of combustion dynamics within the combustion section; and
modifying the fuel cell assembly operating condition in response to receiving data indicative of the combustion dynamics within the combustion section to mitigate the combustion dynamics.

6. The propulsion system of claim 5, wherein receiving data indicative of combustion dynamics within the combustion section comprises determining at least one of a location, an amplitude, and a frequency of the combustion dynamics, and wherein the fuel cell assembly operating condition is modified based at least partially on one of the location, the amplitude, and the frequency of the combustion dynamics within the combustion section.

7. The propulsion system of claim 5, wherein modifying the fuel cell assembly operating condition comprises adjusting a fuel operating condition, wherein adjusting the fuel operating condition comprises adjusting a fuel to air ratio in the fuel processing unit, a fuel processing unit gas hourly space velocity (total gas flowrate), or a combination thereof.

8. The propulsion system of claim 5, wherein modifying the fuel cell assembly operating condition comprises adjusting a fuel cell exhaust condition, wherein the fuel cell exhaust condition includes at least one of a fuel cell assembly output product composition, a fuel cell assembly output product total flowrate, a fuel cell assembly output product air/fuel flowrate ratio, a fuel cell assembly output product temperature, and a fuel cell assembly output product velocity.

9. The propulsion system of claim 5, wherein modifying the fuel cell assembly operating condition comprises adjusting an air operating condition.

10. The propulsion system of claim 5, wherein modifying the fuel cell assembly operating condition comprises modifying an electrical output of the fuel cell.

11. A method of operating a propulsion system for an aircraft, the propulsion system comprising a fuel cell assembly comprising a fuel cell and defining a fuel cell assembly operating condition, the fuel cell defining an outlet positioned to remove output products from the fuel cell and a turbomachine, the turbomachine comprising a combustion section configured to receive a flow of aviation fuel from an aircraft fuel supply of the aircraft and further configured to receive the output products from the fuel cell, the method comprising:
delivering the output products from the fuel cell to the combustion section to mitigate combustion dynamics within the combustion section.

12. The method of claim 11, wherein delivering the output products from the fuel cell to the combustion section comprises:
determining, based on stored data within the lookup table, an amount of the output products and a distribution location of the combustion section,
delivering the amount of the output products from the fuel cell to the distribution location of the combustion section to mitigate the combustion dynamics within the combustion section.

13. The method of claim 11, wherein the fuel cell assembly comprises a fuel cell stack comprising a plurality of fuel cells each defining an outlet positioned at a respective location along the combustion section to remove output products from the respective fuel cell to the respective location, and wherein delivering the output products comprises distributing the output products to one or more of the respective locations to mitigate the combustion dynamics.

14. The method of claim 13, wherein the outlet of each fuel cell is spaced apart from a neighboring outlet of a neighboring fuel cell in at least one of an axial direction or a circumferential direction.

15. The method of claim 11, further comprising:
receiving data indicative of combustion dynamics within the combustion section; and
modifying the fuel cell assembly operating condition in response to receiving data indicative of the combustion dynamics within the combustion section to mitigate the combustion dynamics.

16. The method of claim 15, wherein receiving data indicative of combustion dynamics within the combustion section comprises determining at least one of a location, an amplitude, and a frequency of the combustion dynamics, and wherein the fuel cell assembly operating condition is modified based at least partially on one of the location, the amplitude, and the frequency of the combustion dynamics within the combustion section.

17. The method of claim 15, wherein modifying the fuel cell assembly operating condition comprises adjusting a fuel operating condition, wherein adjusting the fuel operating condition comprises adjusting a fuel to air ratio in the fuel processing unit, a fuel processing unit gas hourly space velocity (total gas flowrate), or a combination thereof.

18. The method of claim 15, wherein modifying the fuel cell assembly operating condition comprises adjusting a fuel cell exhaust condition, wherein the fuel cell exhaust condition includes at least one of a fuel cell assembly output product composition, a fuel cell assembly output product total flowrate, a fuel cell assembly output product air/fuel flowrate ratio, a fuel cell assembly output product temperature, and a fuel cell assembly output product velocity.

19. The method of claim 15, wherein modifying the fuel cell assembly operating condition comprises adjusting an air operating condition.

20. The method of claim 15, wherein modifying the fuel cell assembly operating condition comprises modifying an electrical output of the fuel cell.
